(19) United States
(12) Patent Application Publication
(10) Pub. No.: US 2003/0214947 A1
(43) Pub. Date: Nov. 20, 2003

(54) Method of searching an IP address

(76) Inventor: Fen-Man Chang, Hsin-Chu City (TW)

Correspondence Address: Morton J. Rosenberg, Esq., Rosenberg, Klein & Lee, Suite 101, 3458 Ellicott Center Drive, Ellicott City, MD, 21043, US

(21) Appl. No.: 10/147,821

(22) Filed: May 20, 2002

(51) Int. Cl. H04L 12/28; H04L 12/56

(52) U.S. Cl. 370/392; 370/432

(57) ABSTRACT

A method of searching an IP address is provided. A user interface broadcasts an ICMP request packet to an internet protocol (IP) based network. The ICMP request packet includes a first message type undefined before, a first code number and host information to be searched at the data portion. An IP-related device, thinking the ICMP request packet destined for it, sends out an ICMP reply packet to the user interface. The ICMP reply packet includes a second message type undefined before, a second code number and the host information of the IP-related device at the data portion. The user interface thus obtains an IP address of the IP-related device in accordance with the information of the ICMP reply packet.

### BACKGROUND OF THE INVENTION

1. Field of the Invention The present invention is directed for communication between IP (Internet Protocol) based networks, and more particularly to a method for searching IP addresses of IP-related devices over the IP networks.

2. Description of the Prior Art

As it is known that IP address is the mandatory information for any IP-related device. The IP address identifies both a specific network and a specific device. The network identifier is the same for all devices on the same network. However, the device identifier is unique. Hence, a user needs to know the IP address if the user wants to access such kind of device. If the device has one built-in console, the user can be very easy to know the information including the IP address from the console port. If the device has not built-in console, for example, for an embedded system, maybe the user need to record the IP address at some place that can help him to get it. And, if the IP address is dynamically gotten via a DHCP (Dynamic Host Configuration Protocol) protocol, the IP address is dynamically assigned to the device, the user will not know the current IP address of the device.

There are some mechanisms that help the user to find an IP address. For example, defining one proprietary new protocol to broadcast the query message over IP network. The proprietary new protocol may be located at the MAC (Media Access Control) layer, network layer or one higher-level layer. However, there are some drawbacks for such kind of mechanism. Firstly, the packet will be easily dropped at some intermediate devices, such as routers, because the proprietary new protocol is a non-IP protocol or private protocol. Secondly, the proprietary new protocol will need more storage to keep the algorithm codes. The memory, such as a random access memory or flash memory, is very precious for an embedded system, for example a networking camera. If the embedded system implements the proprietary new protocol, it will need more memory size. As a result, the manufacturing cost is increased. Therefore, it is not suitable for the embedded system to implement the proprietary new protocol.

Accordingly, it is an intention to provide a method for searching an IP address, which modifies one well-known IP protocol to find the IP address of a desired IP-related device, and the above drawbacks also can be overcome.

### SUMMARY OF THE INVENTION

It is one objective of the present invention to provide a method for searching an IP address, which can simultaneously obtain IP addresses of a plurality of same kind of IP-related devices, and thus facilitating a user access the desired IP-related device.

It is another objective of the present invention to provide a method for searching an IP address, which modifies one well-known IP protocol must be implemented by every IP module to search IP addresses. Therefore, an intermediate device does not discard the IP packet and the memory size only increases a little.

It is a further objective of the present invention to provide a method for searching an IP address, which encapsulates an ICMP request/or reply packet with an ICMP message type undefined before communicating over IP based networking for searching IP addresses.

It is still a further objective of the present invention to provide a method for searching an IP address, which modifies an ICMP protocol to create an ICMP request/reply packet with an ICMP message undefined before communicating over IP based networking for searching IP addresses. Both of the memory size and cost increase a little. Hence, the present method is suitable for being implemented in an embedded system.

In order to achieve the above objectives of this invention, the present invention provides a method for searching an IP address. The present method comprises the following steps. Broadcasting an ICMP request packet from a user interface to an internet protocol (IP) based network. The ICMP request packet includes a first message type undefined before, a first code number and host information to be searched at the data portion. When an IP-related device corresponds to the host information, the IP-related device sends out an ICMP reply packet to the user interface. The ICMP reply packet includes a second message type undefined before, a second code number and the host information of the IP-related device at the data portion. Otherwise, the IP-related device discards the ICMP reply packet. And, obtaining an IP address of the IP-related device in accordance with the information of the ICMP reply packet. In accordance with the foregoing, the present invention provides a simple method, which implements a modified ICMP protocol, is capable of quickly search out an IP address of a desired IP-related device. An intermediate device does not discard the ICMP request/reply packets, and the memory size also increases a little. Thus, the present invention is suitable for an embedded system.

### BRIEF DESCRIPTION OF THE DRAWINGS

The objectives and features of the present invention as well as advantages thereof will become apparent from the following detailed description, considered in conjunction with the accompanying drawings.

FIG. 1 is a block diagram illustrating an IP header layout;

FIG. 2A is a block diagram illustrating an ICMP request message layout according to one preferred embodiment of the present invention;

FIG. 2B is a block diagram illustrating an ICMP reply message layout according to the preferred embodiment;

FIG. 3 is a diagram showing a wireless network capable of communicating using packets in conjunction with the present invention; and

FIG. 4 is a flow chart of the method according to one preferred embodiment of the present invention.

### DESCRIPTION OF THE EMBODIMENTS

The present invention provides a method for searching an IP address, which does not need to implement a private protocol, but utilizes a well-known IP protocol must be implemented by every IP module to communicate over IP based networks to search the IP address of a desired IP-related device. Thus, intermediate devices, such as routers, will not discard the packet of the implemented IP protocol, and the memory size only increases a little. More specifically, the present invention utilizes a modified ICMP (Internet Control Message Protocol) protocol to search an IP address. ICMP, uses the basic support of IP (Internet Protocol) as if it were a higher-level protocol, however, ICMP is actually an integral part of IP, and must be implemented by every IP module. ICMP communicates error and administrative message between IP-related devices and it is a required part for any IP-related device.

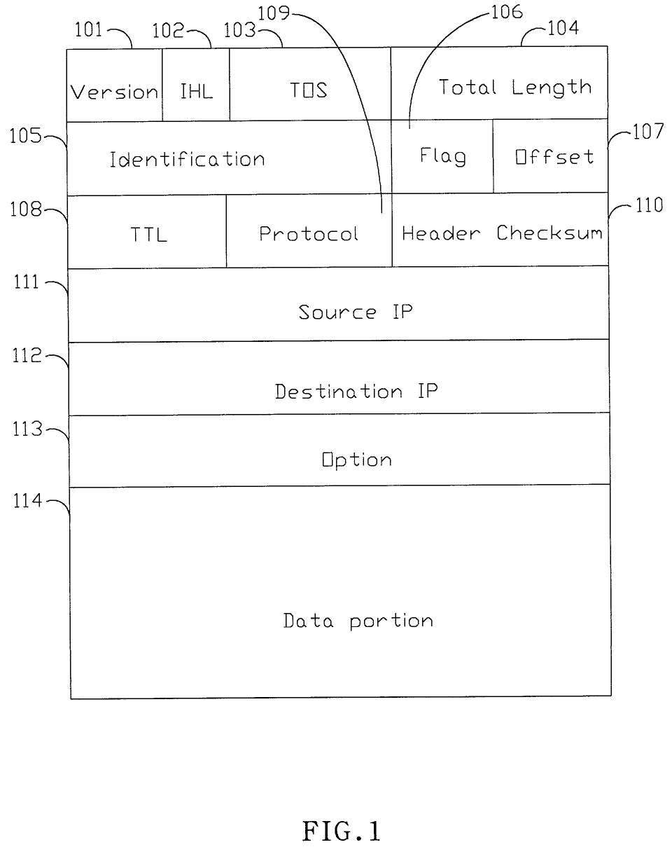

FIG. 1 is a block diagram showing an IP header includes the following fields:

Version (101) The version of the Internet Protocol being used.

IHL (102) Internet header length.

TOS (103) Type of service.

Total length (104) Length of internet header and data in octets.

Identification (105), Flag (106), offset (107) Used in fragmentation.

TTL (108) Time to live; the number of hops a packet can travel before being discarded.

Eprotocol (109) This field identifies the protocol that generates the data in the packet; wherein ICMP=1.

Header Checksum (110) A metric used by the receiving device to ensure that the information in the header is not corrupted on receipt.

Source IP (111) The sender's IP address.

Destination IP (112) Indicates the address of the intended recipient.

Option (113) This field can be used to provide information about the routers, such as addresses and timestamps, that the packet encounters in its path to the destination.

ICMP messages are sent using the basic IP header. The first octet of the data portion (114) of the IP datagram is an ICMP type field; the value of this field determines the format of the remaining data. The ICMP message types having been defined including:

type (0) Echo Reply

type (3) Destination Unreachable

type (4) Source Quench

type (5) Redirect

type (8) Echo

type (9)(10) Used for ICMP Router Discovery Message

type (11) Time Exceeded

type (12) Parameter Problem

type (13) Timestamp

type (14) Timestamp Reply

type (15) Information Request

type (16) Information Reply

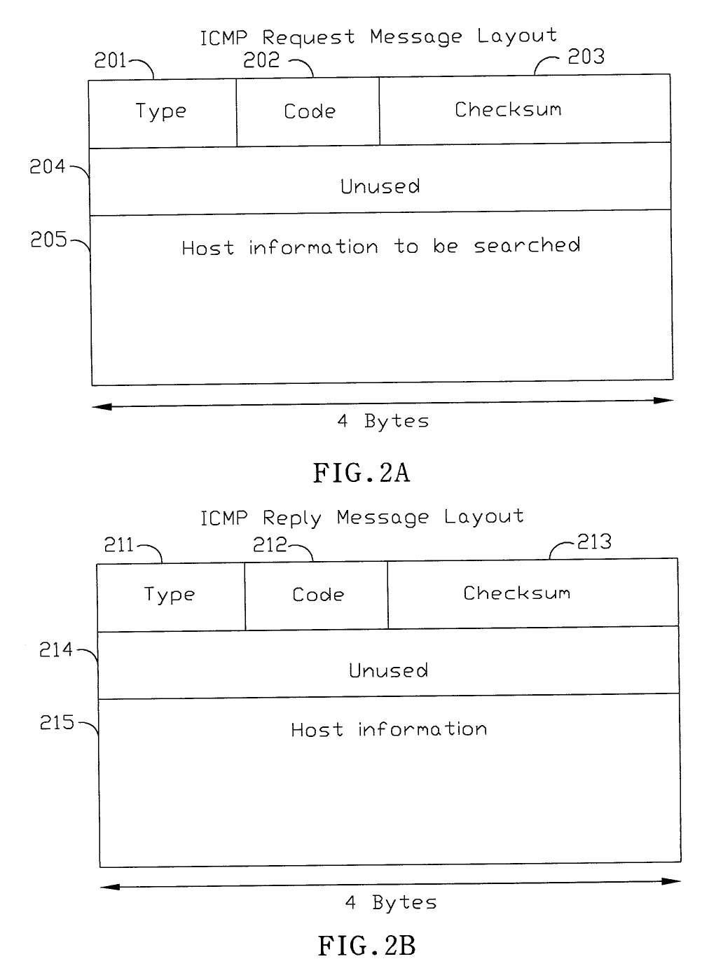

The present invention utilizes the ICMP protocol with undefined message type before to broadcast the query message for searching the IP address of an IP-related device, for example a networking camera, networking tablet or another networking device. FIG. 2A is a block diagram illustrating an ICMP request message layout according to one preferred embodiment of the present invention, and FIG. 2B is a block diagram illustrating an ICMP reply message layout according to the preferred embodiment of the present invention.

Referring to FIGS. 2A and 2B, type-field 201/211 is one-byte, and the value of type “1” is defined as a request message type in the preferred embodiment of the present invention, and the value of type “2” is defined as a reply message type in the preferred embodiment. However, other values of ICMP message type undefined before also can be used to create the request/reply message type in the present invention. Code-field 202/212 is one byte, and has a value of zero for request and one for reply. Checksum-field 203/213 is two bytes and is a 16-bit 1's complement sum of the entire ICMP request/reply message. Any field labeled “unused 204/214” is reserved for later extensions and must be zero when sent, but receivers should not use these field (except to include them in the checksum). For the ICMP request packet in the preferred embodiment, as shown in FIG. 2A, the host information of an IP-related device or a plurality of same kind of IP-related devices to be searched is defined in the data portion 205. For example, if a user wants to search the IP address of a networking camera or a plurality of networking camera, the character “camera” can be represented in the data portion 205. For the ICMP reply packet in the preferred embodiment, shown in FIG. 2B, the host information, such as host name and/or further information, of the IP-related device thinking the query message is destined for it, is defined in the data portion 215, for example, in a form of character “camera”.

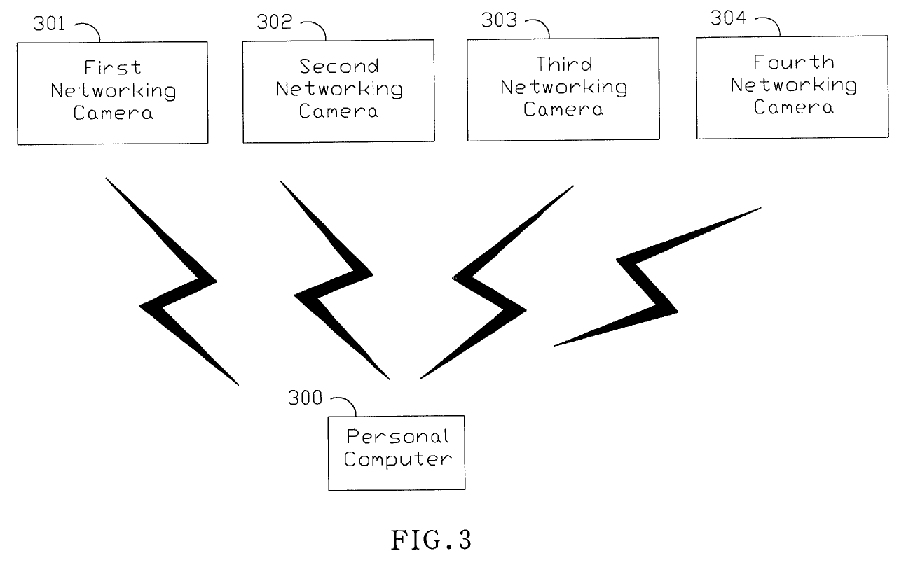

FIG. 3 is a diagram showing a wireless IP network capable of communicating using packets in conjunction with the present invention. When a user desires to observe a meeting conducting in a third-floored conference room through the personal computer 300, the user will need to known the IP address of the third networking camera 303. Then, the user can access the device through the personal computer 300 to observe the images concerning the meeting conducting in the conference room captured by the device.

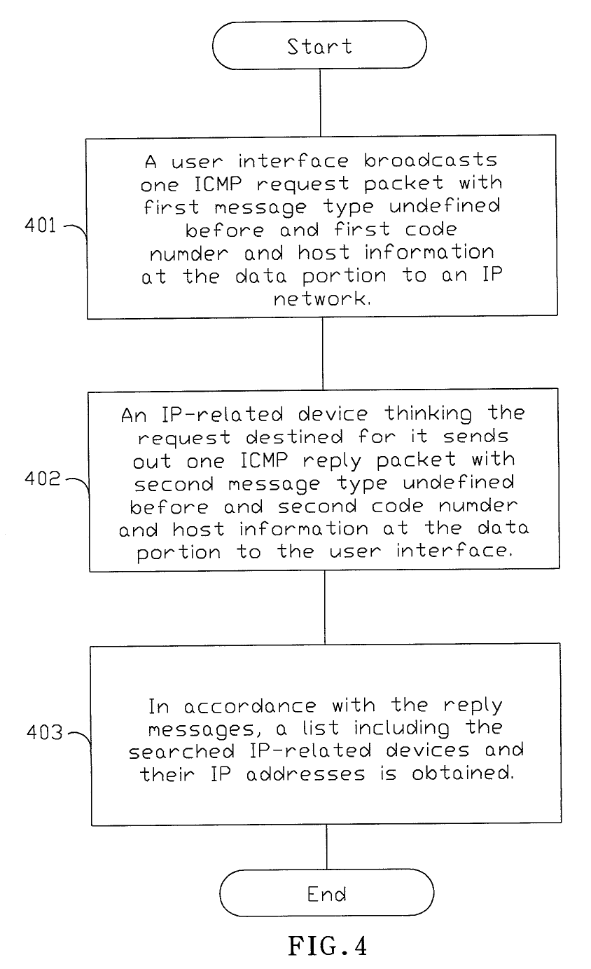

FIG. 4 is flow chart of the present method according to the preferred embodiment, illustrating how to search the IP address of a desired IP-related device. The user can utilize the present method of FIG. 4 to simultaneously find the respective IP addresses of the first networking camera 301, the second networking camera 302, the third networking camera 303 and the fourth networking camera 304. Initially, at step 401, an user interface, such as the personal computer 300, or a palm digital assistant or another self-controlled networking device, broadcasts one ICMP request packet with first message type undefined before and first code number and host information at the data portion to an IP based network, such as a local area network, internet network or an intranet network. The format of the ICMP request packet is illustrated in FIG. 2A. In the example of FIG. 3, the value of the first message type can be “1” and the first code number can be “0”, and the host information, such as host name “camera” can be represented in the data portion of the ICMP request packet. In step 402, when an IP-related device receives the ICMP request packet, ICMP protocol will check the information in the ICMP request packet because the protocol of the IP header with the ICMP request packet is “1”. If the IP-related device thinks the query message is the information destined for it, i.e. the IP-related device corresponds to the host information to be searched, the IP-related device will send out one ICMP reply packet with a second message type undefined before and a second code number and host information itself at the data portion to the user interface. The format of the ICMP reply packet is illustrated in FIG. 2B. In the example of FIG. 3, the value of the second message type can be “2” and the second code number can be “1”, and the host name “camera” and/or further information can be represented in the data portion of the ICMP reply packet. In step 403, in accordance with the reply message, the user interface can obtain the IP address of the desired IP-related device from source IP-field 111 of IP header, as shown in FIG. 1. On the other hand, the user interface can simultaneously get respective reply messages sent from a plurality of same kind of IP-related devices, and accordingly obtaining a list including the respective host information of the IP-related devices and IP addresses corresponding thereto. Then, the user can base the respective host information to determine which is the one he wants to access.

The present invention implements a simple method to search the IP address of a desired IP-related device, which does not need to define a private protocol, but create one ICMP request/reply packet utilizing the message types undefined before to find out the IP address. Therefore, the present invention provides some advantages as below: (I) The ICMP request/reply packet will not be dropped at some intermediate devices, such as routers, because it is a IP protocol; and (II) The memory size only increases a little, and it is suitable for an embedded system.

The embodiments are only used to illustrate the present invention, not intended to limit the scope thereof. Many modifications of the embodiments can be made without departing from the spirit of the present invention.

What is claimed is:

1. A method of searching an IP address, comprising:
broadcasting an ICMP request packet from a user interface to an internet protocol (IP) based network, said ICMP request packet including a first message type undefined before, a first code number and host information to be searched at the data portion;
when an IP-related device corresponds to said host information, the IP-related device sends out an ICMP reply packet to the user interface, said ICMP reply packet including a second message type undefined before, a second code number and the host information of the IP-related device at the data portion, and otherwise, the IP-related device discards said ICMP reply packet; and
obtaining an IP address of the IP-related device in accordance with the information of said ICMP reply packet.

2. The method of claim 1, wherein said user interface is a personal computer, palm digital assistant or another self-controlled netwroking device.

3. The method of claim 1, wherein said ICMP request packet includes an IP header with source IP address and destination IP address.

4. The method of claim 1, wherein said ICMP reply packet includes an IP header with source IP address and destination IP address.

5. The method of claim 1, wherein said first message type is any of ICMP message type (1) or ICMP message type (2).

6. The method of claim 1, wherein said second message type is any of ICMP message type (1) or ICMP message type (2) different from said first message type.

7. The method of claim 1, wherein the IP-related device is any of a networking camera, networking tablet and another networking device.

8. The method of claim 1, wherein the internet protocol based network includes a local area network, internet network and an intranet network.

9. A method of searching IP addresses, comprising:
broadcasting an ICMP request packet from a user interface to an internet protocol (IP) based network, said ICMP request packet including a first message type undefined before, a first code number and host information to be searched at the data portion;
when a plurality of same kind of IP-related devices corresponds to said host information, each of the IP-related devices sends out an ICMP reply packet to the user interface, said ICMP reply packet including a second message type undefined before, a second code number and the host information of the IP-related device at the data portion, and otherwise, the IP-related devices discard said ICMP reply packet; and
obtaining a list showing the IP-related devices and IP addresses corresponding thereto in accordance with the information of said ICMP reply packets.

10. The method of claim 9, wherein said user interface is a personal computer, palm digital assistant or another self-controlled networking device.

11. The method of claim 9, wherein said ICMP request packet includes an IP header with source IP address and destination IP address.

12. The method of claim 9, wherein said ICMP reply packet includes an IP header with source IP address and destination IP address.

13. The method of claim 9, wherein said first message type is any of ICMP message type (1) or ICMP message type (2).

14. The method of claim 9, wherein said second message type is any of ICMP message type (1) or ICMP message type (2) different from said first message type.

15. The method of claim 9, wherein the IP-related device is any of a networking camera, networking tablet and another networking device.

16. The method of claim 9, wherein the internet protocol based network includes a local area network, internet network and an intranet network.
